(19) United States
(12) Patent Application Publication
(10) Pub. No.: US 2009/0314046 A1
(43) Pub. Date: Dec. 24, 2009

(54) PRODUCTION OF A HIGH PHOSPHORUS FERTILIZER PRODUCT

(76) Inventors: Michael Rieth, Woodbury, MN (US); Claude Anderson, Arden Hills, MN (US)

Correspondence Address: CLAUDE T. ANDERSON, 1758 VENUS AVE, ARDEN HILLS, MN, 55112, US

(21) Appl. No.: 12/486,802

(22) Filed: Jun. 18, 2009

Related U.S. Application Data
(60) Provisional application No. 61/074,003, filed on Jun. 19, 2008.

(51) Int. Cl. C05F 3/04

(52) U.S. Cl. 71/12

(57) ABSTRACT

This invention is related to methods for the production of high phosphorus fertilizer products from waste products. In particular, the method describes the production of liquid and dry fertilizer products produced from the incineration of wastewater treatment sludges utilizing biological phosphorus removal (Bio-P). The fertilizers produced can be used interchangeably for commercial purposes either directly as a fertilizer product, or mixed with other conventional products to produce custom blended fertilizers for particular purposes.

### CROSS REFERENCE TO RELATED APPLICATIONS

This application claims priority to Provisional Application 61/074,003 filed Jun. 19, 2008.

### BACKGROUND OF THE INVENTION

Global phosphate reserves are a finite resource, occurring exclusively as phosphate ore. Through an increasing reliance of many industries on phosphate, there is a growing necessity for sustainable phosphate management. Phosphate ore is found worldwide but, with current extraction practices, mining is focused in three countries: United States, China, and Morocco.

It was estimated in 2001, by the U.S. Geological Survey USGS, that the global reserve life of phosphate ore was approximately 90 years Roberts and Stewart 2002. This is far different from its previous 5-year trend estimate, made in 1996, of 160 years.

Of more immediate concern to the North American fertilizer industry is the fact that the U.S. reserve life is estimated at only 25 years Roberts and Stewart 2002. The end result is that, in the next quarter century, the United States will go from being a dominant exporter of phosphorus P to the largest global consumer. USGS mineral progress reports in 2003 have indicated a decrease in domestic production of nearly 10% from 2002 to 2003 USG.

This invention is related to methods for the production of high phosphorus fertilizer products from waste products. In particular, the method describes the production of liquid and dry fertilizer products produced from the incineration of wastewater treatment sludges utilizing biological phosphorus removal (Bio-P). The fertilizers produced can be used interchangeably for commercial purposes either directly as a fertilizer product, or mixed with other conventional products to produce custom blended fertilizers for particular purposes.

### SUMMARY OF THE INVENTION

This invention is related to methods for the production of high phosphorus fertilizer products from waste products. In particular, the method describes the production of liquid and dry fertilizer products produced from the incineration of wastewater treatment sludges utilizing biological phosphorus removal (Bio-P).

Sludges produced from Bio-P contain high concentrations of phosphorus which must be removed from the wastewater process. The phosphorus may be concentrated by incineration which removes volatile compounds such as carbon, nitrogen and mercury. Incineration also has the feature of producing a pathogen free product due to the elevated temperatures used.

The ash produced can be used interchangeably with commercial fertilizers for agronomic or horticultural purposes either directly as a fertilizer product or blended with other conventional products to produce custom fertilizers. The ash produced may also be palletized or liquefied to produce additional fertilizer products.

The manufacture of most commercial phosphate fertilizers begins with the production of phosphoric acid. Historically, rock phosphate is used to produce phosphoric acid. In the present invention, Bio-P product such as incinerator ash may be used. In another embodiment, Bio-P sludge may also be used instead of the incinerator ash. Phosphoric acid is produced by either a dry or wet process. In the dry process, rock phosphate is treated in an electric furnace. This treatment produces a very pure and more expensive phosphoric acid (frequently called white or furnace acid) used primarily in the food and chemical industry. Fertilizers that use white phosphoric acid as the P source are generally more expensive because of the costly treatment process.

The wet process involves treatment of the rock phosphate with acid producing phosphoric acid (also called green or black acid) and gypsum which is removed as a by-product. The impurities which give the acid its color have not been a problem in the production of dry fertilizers. Either treatment process (wet or dry) produces orthophosphoric acid—the phosphate form that is taken up by plants.

The phosphoric acid produced by either the wet or the dry process is frequently heated, driving off water and producing a superphosphoric acid. The phosphate concentration in superphosphoric acid usually varies from 72 to 76%. The P in this acid is present as both orthophosphate and polyphosphate. Polyphosphates consist of a series of orthophosphates that have been chemically joined together. Upon contact with soils, polyphosphates revert back to orthophosphates.

Ammonia can be added to the superphosphoric acid to create liquid or dry materials containing both nitrogen (N) and P. The liquid, 10-34-0, is the most common product. The 10-34-0 can be mixed with finely ground potash (0-0-62), water, and urea-ammonium nitrate solution (28-0-0) to form 7-21-7 and related grades. The P in these products is present in both the orthophosphate and polyphosphate form. If Bio-P sludge is used as a feed product, nitrogen will be present with the phosphorus, and lesser amounts or no nitrogen may need to be added to achieve a given nitrogen content in the fertilizer.

It is an object of this invention to produce a fertilizer from municipal sewage sludge, which is easily stored, handled and delivered.

Another object of the invention is to produce a fertilizer material using sewage sludge, thickened sludge, incinerator ash, fly ash, or various mixtures, which are suitable for use as a fertilizer material or can be further processed to produce a fertilizer material.

Still another object of this invention is to produce a feed material that can be blended with other feed materials such as raw ore to provide a product that may have improved quality characteristics such as lower contaminate levels or improved physical or storage characteristics.

Yet a further object of the invention is to produce a stabilized sewage sludge composition which is substantially free of pathogenic agents.

A further object of the invention is to provide a method of and system for utilizing ash and sewage sludge from Bio-P processes whereby the materials are handled during transit and processed in a manner which is pollution free.

Yet another object is to provide a process and system for utilizing ash and sewage sludge in which the end product will harden into a stable, environmentally acceptable product.

### BRIEF DESCRIPTION OF THE SEVERAL VIEWS OF THE DRAWINGS

FIG. 1 shows the effect of various acid to ash ratios on the phosphate content of the liquid product.

FIG. 2 shows the amount of phosphate solubilized at varying ash to acid ratios.

FIG. 3 shows the effect of product pH due to acid strength.

FIGS. 4A and 4B show a schematic representation of a wastewater treatment plant.

FIG. 5 shows the effect of ash phosphorus concentration on recycle and wastewater effluent phosphorus concentrations.

FIG. 6 shows the effect of sludge phosphorus concentration on recycle and wastewater effluent phosphorus concentrations.

FIG. 7 shows example chemical characteristics of Bio-P sludge.

FIG. 8 shows example chemical characteristics of Bio-P dewatered sludge cake.

FIG. 9 shows example chemical characteristics of Bio-P ash.

FIG. 10 shows the results of computer predictive modeling on sludge characteristics.

FIG. 11 shows example chemical parameter analysis based on various particle size distribution various ash, sludge and grit materials from a Bio-P wastewater treatment plant.

FIG. 12 shows example chemical parameter analysis based on various particle size distribution various ash, sludge and grit materials from a Bio-P wastewater treatment plant.

FIGS. 13A and 13B show the results of test results of phosphate removal from ash at various amounts and concentration of acid.

FIG. 14A-FIG. 14H show the test results for chemical parameters associated with Bio-P ash, liquid sludge and dewatered sludge cake.

### DETAILED DESCRIPTION OF THE INVENTION

This invention is related to methods for the production of high phosphorus fertilizer products from waste products. In particular, the method describes the production of liquid and dry fertilizer products produced from the incineration of wastewater treatment sludges utilizing biological phosphorus removal (Bio-P). The fertilizers produced can be used interchangeably with for commercial purposes either directly as a fertilizer product, or blended with other conventional products to produce custom fertilizers.

Currently, there are five main driving forces behind the development of P recovery: the diminishment of global high quality phosphate reserves; the reduction in the return of rereleased phosphorus from anaerobic sludge digestion to the headworks of wastewater treatment plants WWTP; improved sludge management in advanced WWTP AWWTP; control of struvite encrustation in biological nutrient removal BNR plants; and, marketability of struvite as a sustainable product.

U.S. Pat. No. 4,056,465 a modified activated sludge system is disclosed wherein BOD-containing wastewater and recycled sludge are initially admixed under anaerobic conditions in the substantial absence of oxygen or oxidizing agents and subsequently subjected to aeration and clarification. Nitrates and nitrites are removed by interposing an anoxic treating zone between the anaerobic zone and the aerating zone. The patent suggests that the initial admixture of the recycled sludge or biomass with the wastewater influent be under anaerobic conditions such that the basin or zone in which the mixed liquor is first formed is substantially free of nitrites or nitrates and dissolved oxygen.

In U.S. Pat. No. 4,271,026 there is described a wastewater treatment process for enhanced phosphorus removal at adequately high rate process operations. This is accomplished by maintaining a particular set of interrelated operating conditions within a specific envelope in the type of process where recycled activated sludge is mixed with a wastewater influent containing phosphate and BOD under anaerobic conditions, thereby promoting selective production of the desired type of microorganism.

In U.S. Pat. No. 4,488,968 a treatment of wastewater is described in which the wastewater influent is initially mixed with recycle active sludge in an anaerobic zone and then subjected to aeration in an aerobic zone, wherein the residence time of the mixed liquor in the aerobic zone is reduced. At least part of the sludge separated from the mixed liquor is subjected to further oxidation in a separate zone before admixture with the wastewater influent.

The process disclosed in U.S. Pat. No. 4,948,510 employs a plurality of basins which may be individually controlled to achieve anaerobic, anoxic or aerobic conditions. The basins are reconfigurable in that the flow of effluent to a basin, transfer of mix liquor between basins and effluent discharge from a basin can be varied to create a treatment cycle which has features of both continuous and batch processes while minimizing recycle rates and hydraulic level changes. Other return activated sludge wastewater treatment processes have been disclosed which utilize various anoxic and aeration zones or cells to biologically remove phosphorus and nitrogen.

For example, in U.S. Pat. No. 4,867,883 there is described a wastewater treatment process wherein the return sludge is denitrified by the mixed liquor suspended solids (MLSS) from a preceding anaerobic zone which receives an internal recycle from an anoxic zone.

In U.S. Pat. No. 4,999,111 there is described a wastewater treatment process in which the return sludge is pretreated (nitrified) by unaerated contact of fermentation liquids produced from primary sludge. This contact is completed in one or more stages and the initial stage may be anoxic or anaerobic depending on the nitrate content of the return sludge.

Additionally, in U.S. Pat. No. 4,956,094, a wastewater treatment process for the removal of phosphorus is described. This process involves the addition of carbonaceous oxygen demand (COD) or BOD containing liquors to a portion of the return activated sludge (RAS) which is mixed anaerobically and then settled to separate released soluble phosphates and the solids. The anaerobic mix zone consists of a pre-stripper followed by the settling unit with soluble phosphorus removed from the supernatant liquid by chemical precipitation.

Another method for removing nitrogen from wastewater includes the step feed activated sludge process. The step feed process has been successful as applied to nitrification-denitrification wastewater treatment processes. There have been attempts at biologically controlling nitrogen and phosphorus by incorporating an anoxic zone downstream from a series of preceding zones that would typically include aerobic and anaerobic zones. In order to remove and control those pollutants traditionally considered of prime importance, such as ammonia nitrogen, BOD, and phosphorus, these biological processes require that the anaerobic and aerobic zones be disposed in initial stages of treatment. For example, anaerobic zones, necessary for biological phosphorus removal, deplete microorganism food source, i.e., BOD. Consequently, by the time the wastewater mixed liquor has reached the downstream anoxic zone, there is very little, if any, food source for the microorganisms.

Without food, the effectiveness of downstream denitrification is seriously hampered and usually inefficient. Besides that, the overall effectiveness of such a biological denitrification dephosphorization process depends on flow in the overall makeup of the wastewater which can vary sharply from time to time. Many systems have been proposed for utilizing the above phenomena to remove nutrients from municipal wastewater. The well-known A/O and A2/0 processes developed by Air Products and Chemicals, Inc. (USA) are mainstream BPR processes that expose mixed return activated sludge and wastewater to anaerobic conditions for BPR organism selection prior to discharge into the mainstream aerobic zone. The A/O and A2/0 processes lack desirable control over the BPR selection process because the anaerobic zone is directly in the mainstream where plant influent flow rates and conditions vary considerably. The A/O and A2/0 processes often may require chemical precipitation of phosphorus in order to bring phosphorus levels in the effluent to an acceptable level.

The Phostrip process of Biospherics, Inc. (USA) accomplishes the biological removal of phosphorus in the return activated sludge through an anaerobic “stripping tank”. Sludge solids from the stripper are returned to the mainstream aerobic zone where they provide organisms for treating the mainstream. A liquid (supernatant) separated from the solids in the stripper is treated with lime to form a phosphate precipitate that is removed in a settler. Thus, in the Phostrip process biological phosphorus removal is supplemented by a sidestream chemical precipitating process.

More recently, a sidestream system for selection of the desirable BPR organisms, the so called “UNC Process” sidestreams the entire return activated sludge flow to an anaerobic zone where desirable BPR organisms are selected. A fermenter serves to ferment primary sludge to supply the food used in the BPR selection process. Variations on the UNC process are described in U.S. Pat. Nos. 4,874,519; 4,999,111 and 5,022,993. While many processes have been proposed to utilize the phenomenon of uptake of phosphorus by BPR organisms, there is still a need to further improve the “selection” process for desirable BPR organisms so that a municipal wastewater treatment plant can operate within its wide range of influent flow and characteristics, while reliably removing phosphorus in the waste-water to desirable levels well below 1 mg/l.

Typically, Bio-P sludge is generally, landfilled, land applied or incinerated. The cost structures and environmental issues associated with these disposal options is well known. Generally, to reduce material handling expenses Bio-P sludge (which is 96 to 98 percent water) is de-watered before final disposal. The first step in this process is to mix a polymer solution with the liquid sludge. The polymer is a floculant. This means the polymer is used to “charge” the sludge particles, so they will tend to clump, or floc, making it easier to separate the solids from the water.

After being treated with polymer, the sludge is pumped into centrifuges where centrifugal force is used to remove the excess water from the sludge. This drier sludge is referred to as sludge cake. Although the sludge cake is still about 70 percent water, it is now ready for incineration, or hauling.

Typically sludge is burned in a fluidized bed or multiple hearth incinerator. A fluidized bed may have one hearth which is equipped with openings to allow air to be blown through the hearth. The flow of air raises and suspends a layer of sand above the hearth. The sand is heated to approximately 1400° F.

As the sludge is pumped into the incinerator, it comes in contact with the fluidized bed of hot sand and instantaneous evaporation, then combustion occurs. The same air flow that suspends the sand blows the ash out of the incinerator and into the air scrubbing system where the ash and some of the fine sand is removed. A sand silo provides “make-up” sand to replace what is removed with the exhaust from the incinerator.

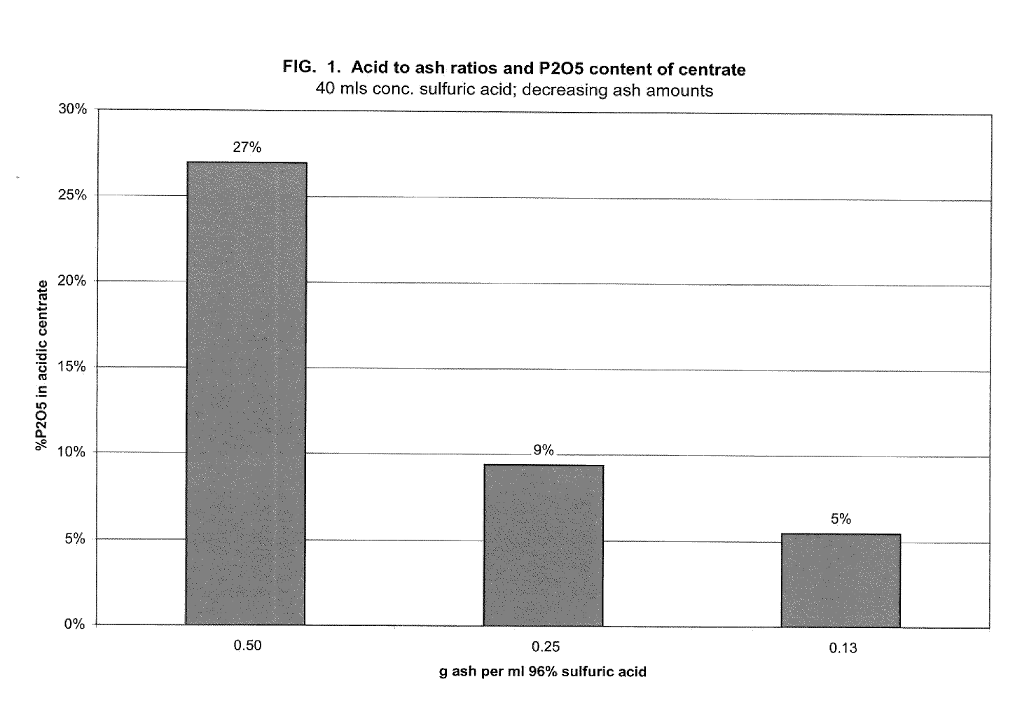

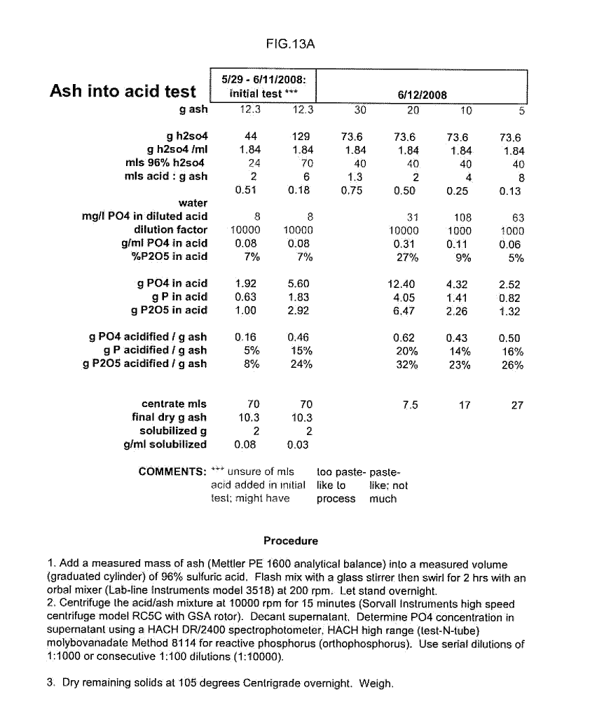

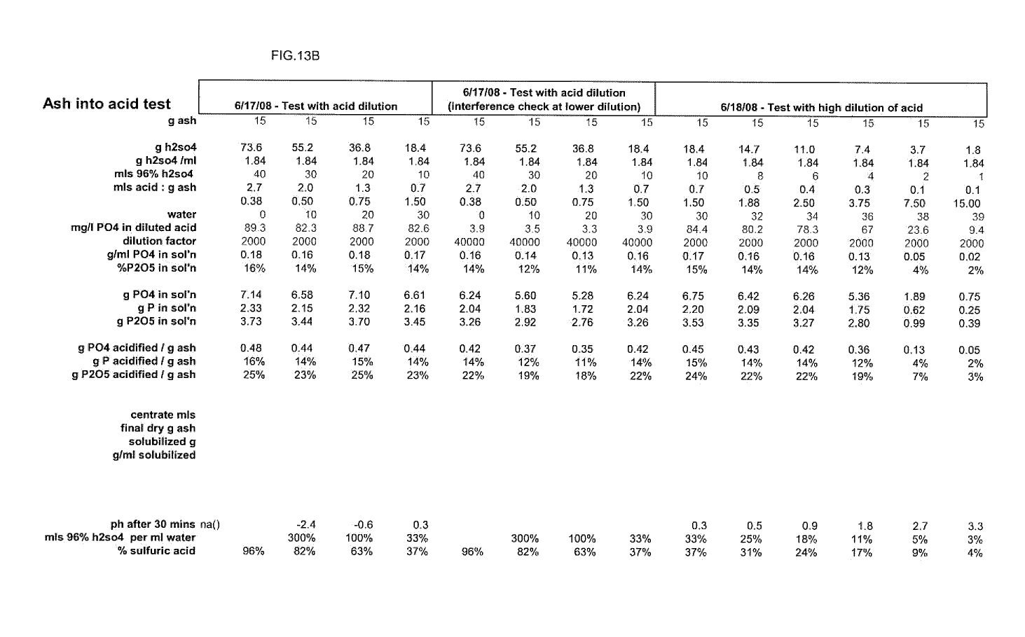

FIG. 1 shows the effect of various acid to ash ratios on the phosphate content of the liquid product. This plot is based on results shown in FIG. 13A, results of Jun. 12, 2008. It is apparent that very strength liquid phosphate may be obtained, with increased quantities of acid diluting the phosphate content of the liquid phase.

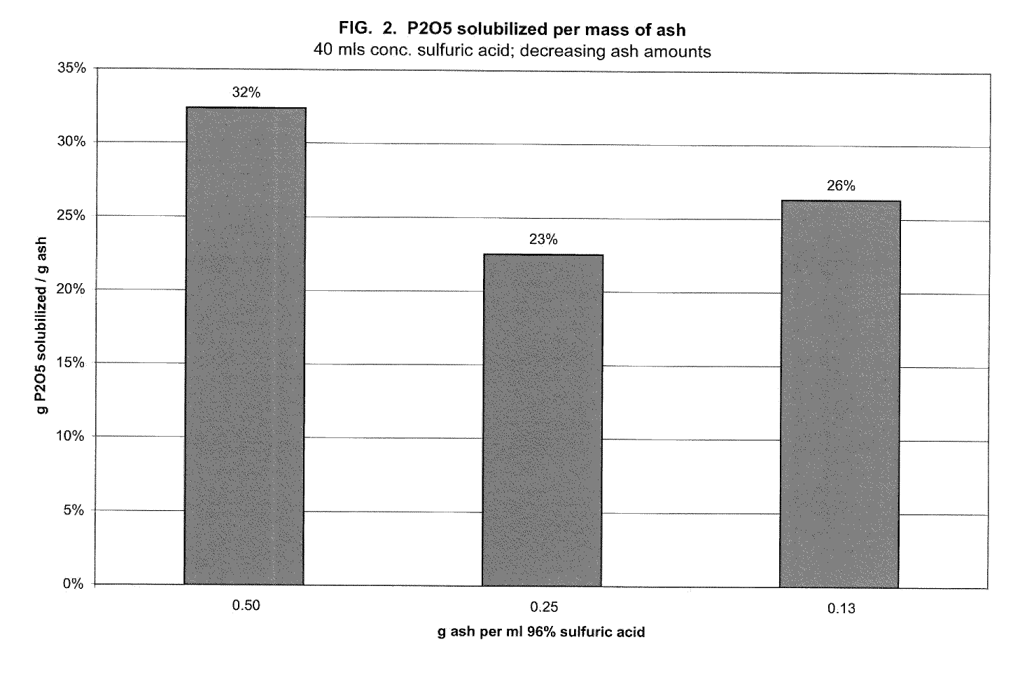

FIG. 2 shows the mass of phosphate solubilized, on a unit basis, at varying ash to acid ratios according to the test shown in FIG. 13A.

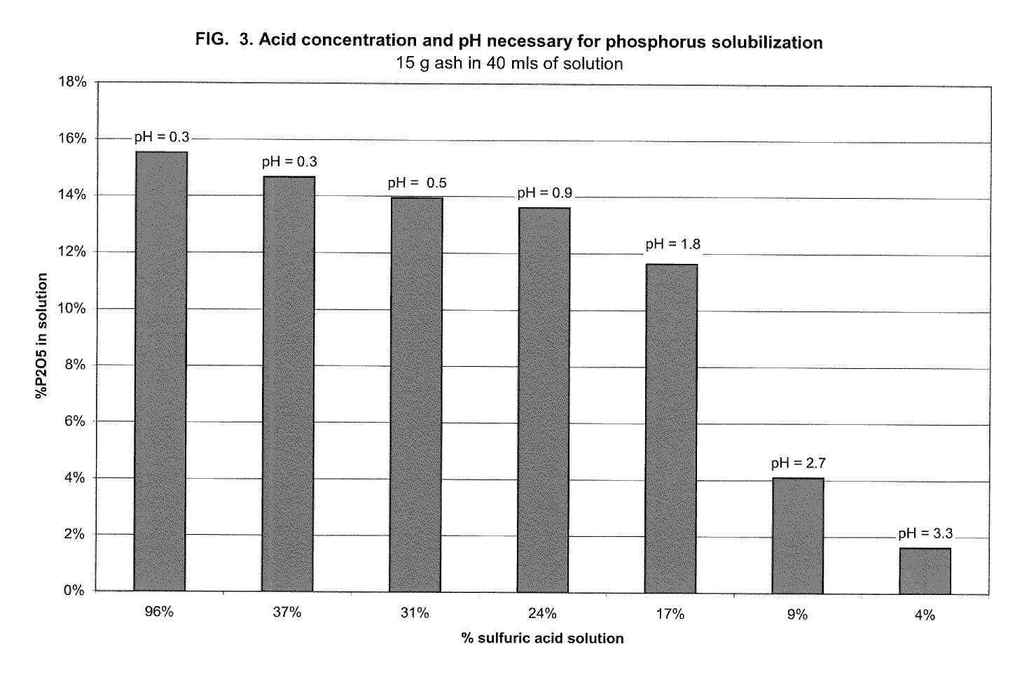

FIG. 3 shows the effect of product pH due to acid strength based on the test reported in FIG. 13B. As would be expected, lower strength acid solutions result in higher pH solutions after phosphate extractions.

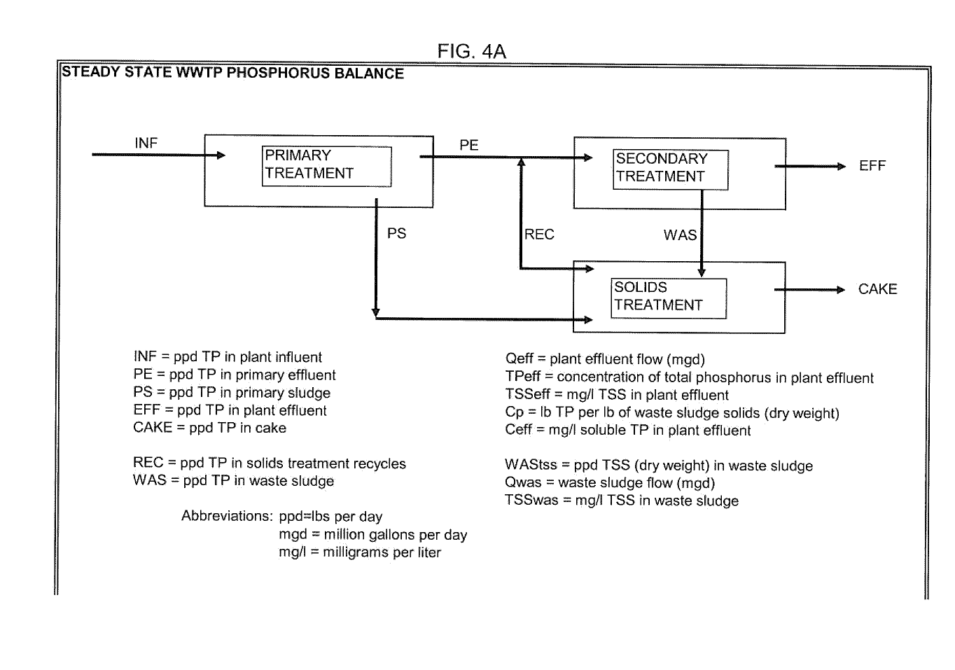

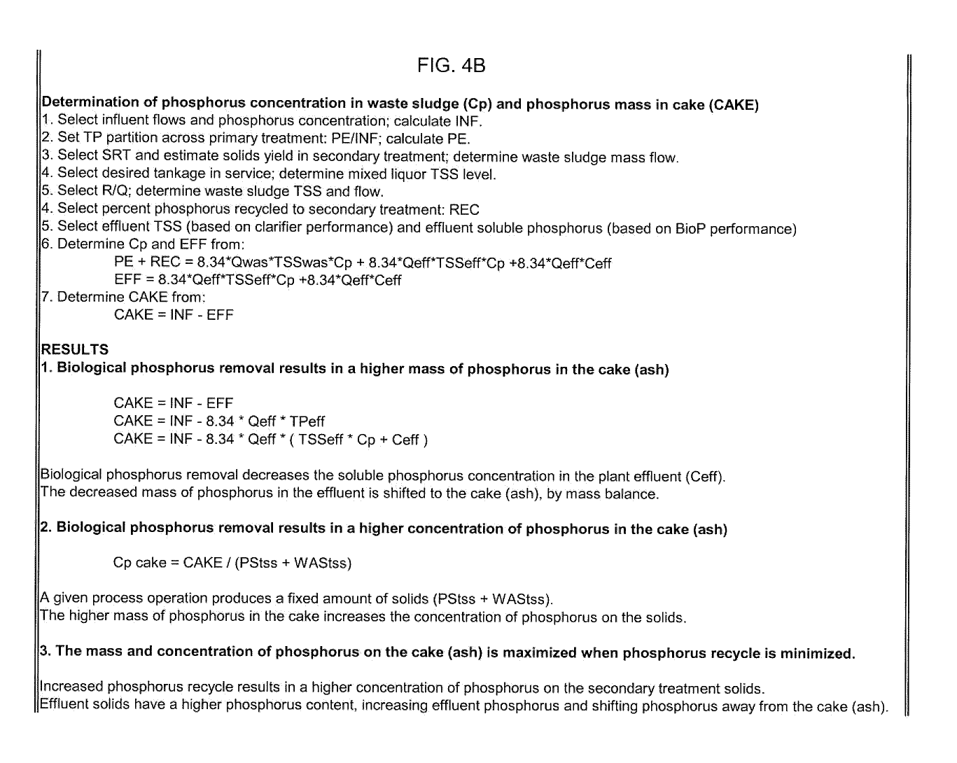

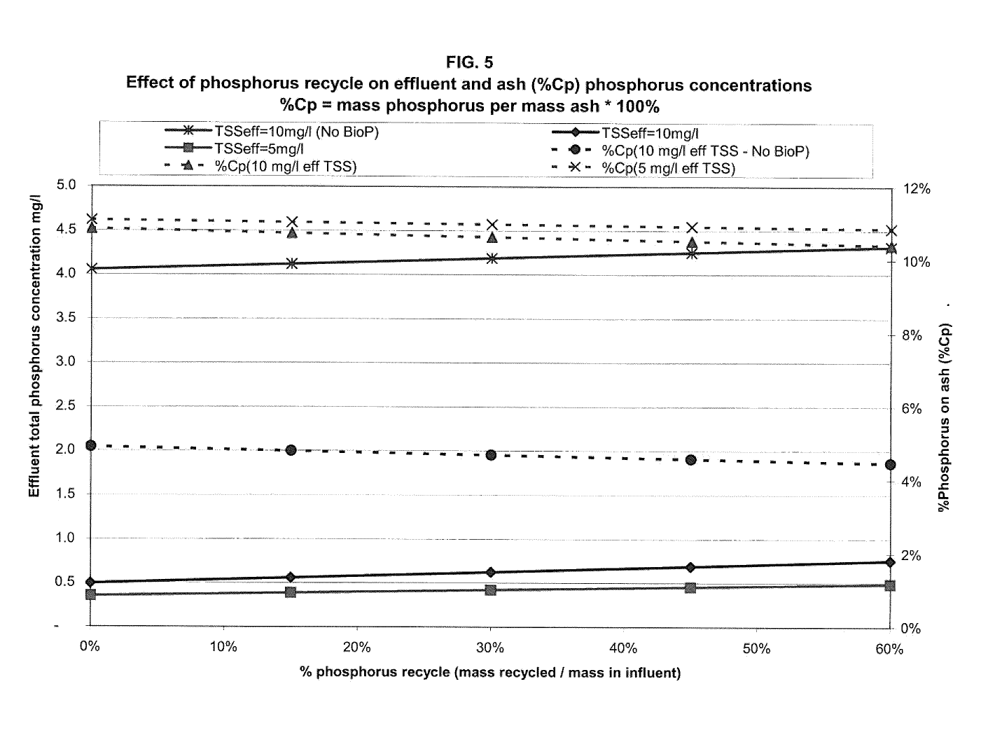

FIGS. 4A and 4B show a schematic representation of a wastewater treatment plant used for modeling purposes to produce the results shown in FIGS. 5, 6 and 10.

FIG. 5 shows the effect of ash phosphorus concentration on recycle and wastewater effluent phosphorus concentrations.

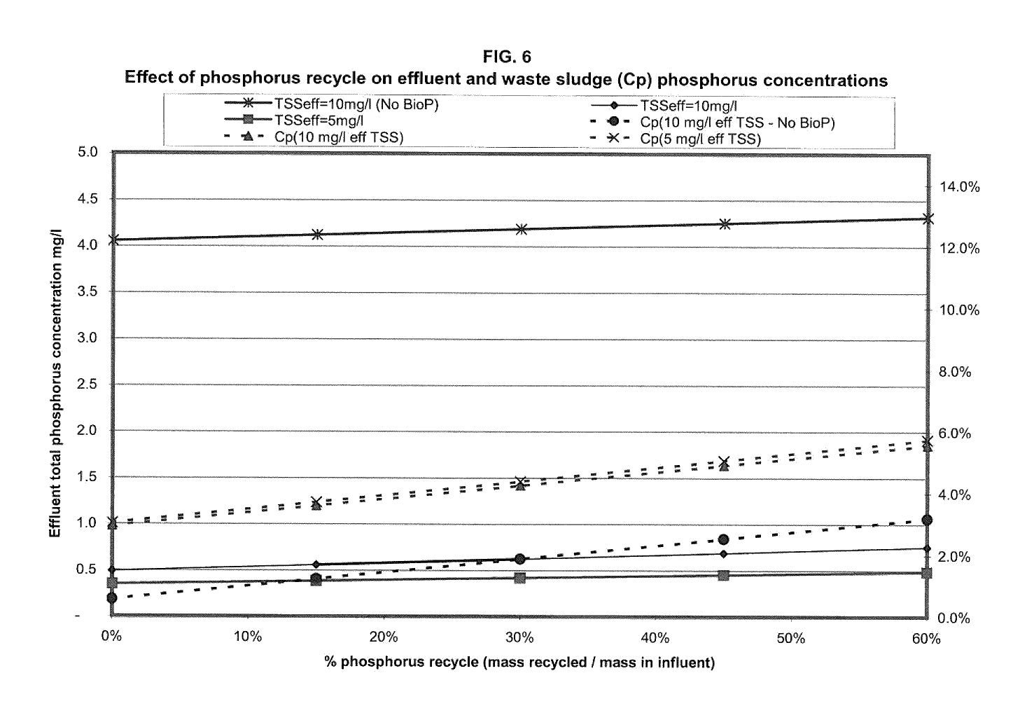

FIG. 6 shows the effect of sludge phosphorus concentration on recycle and wastewater effluent phosphorus concentrations.

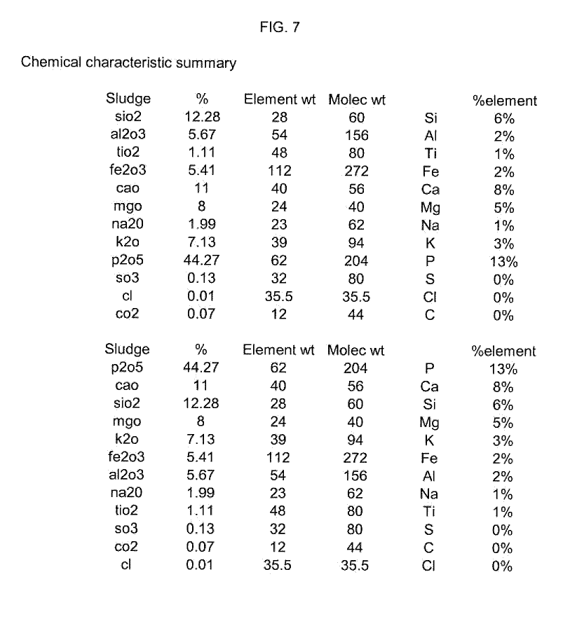

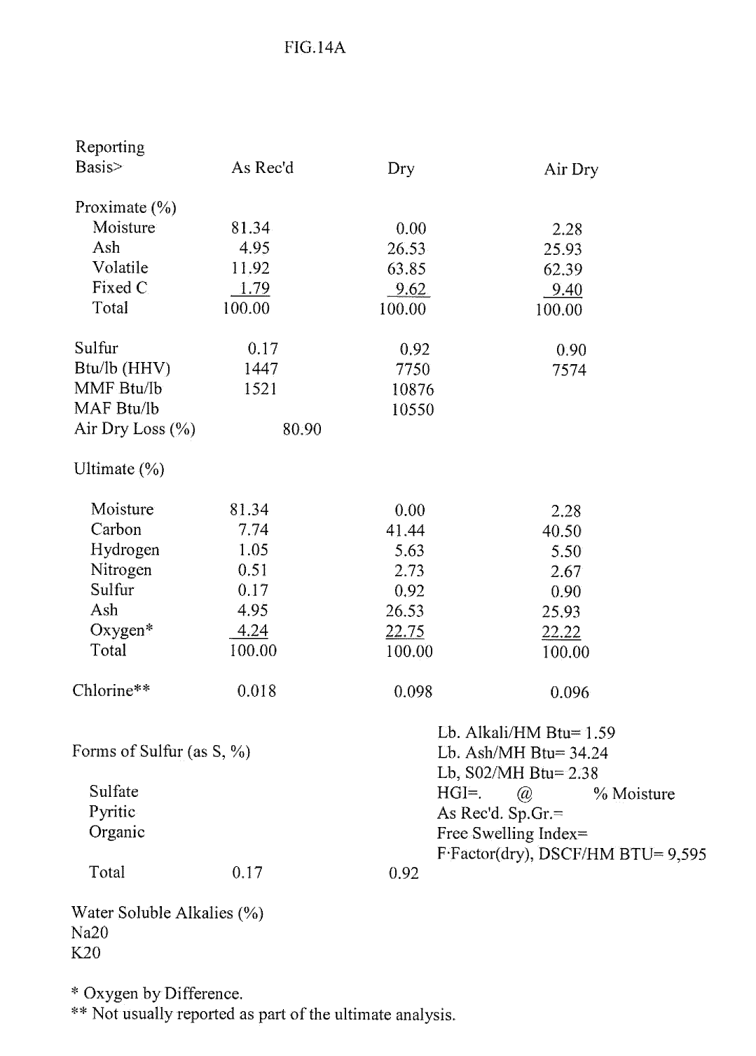

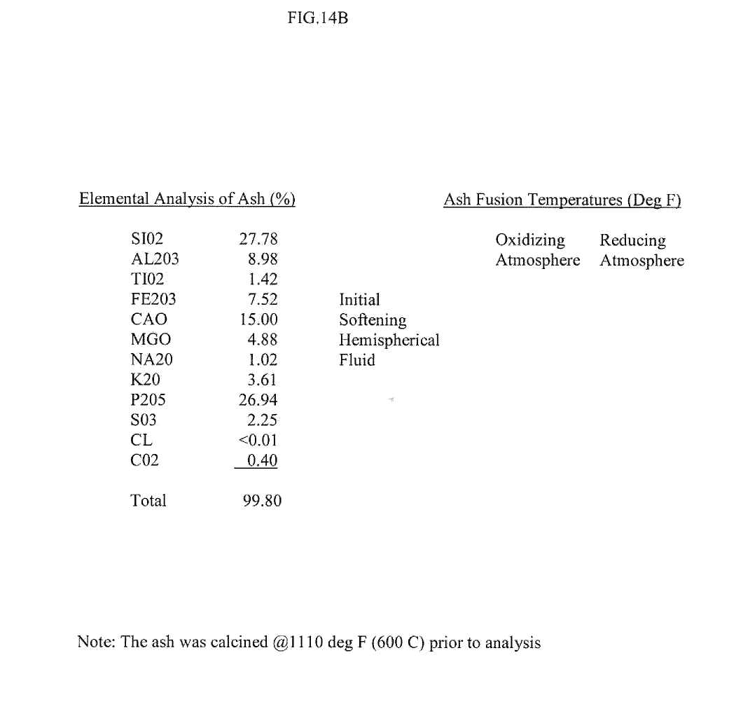

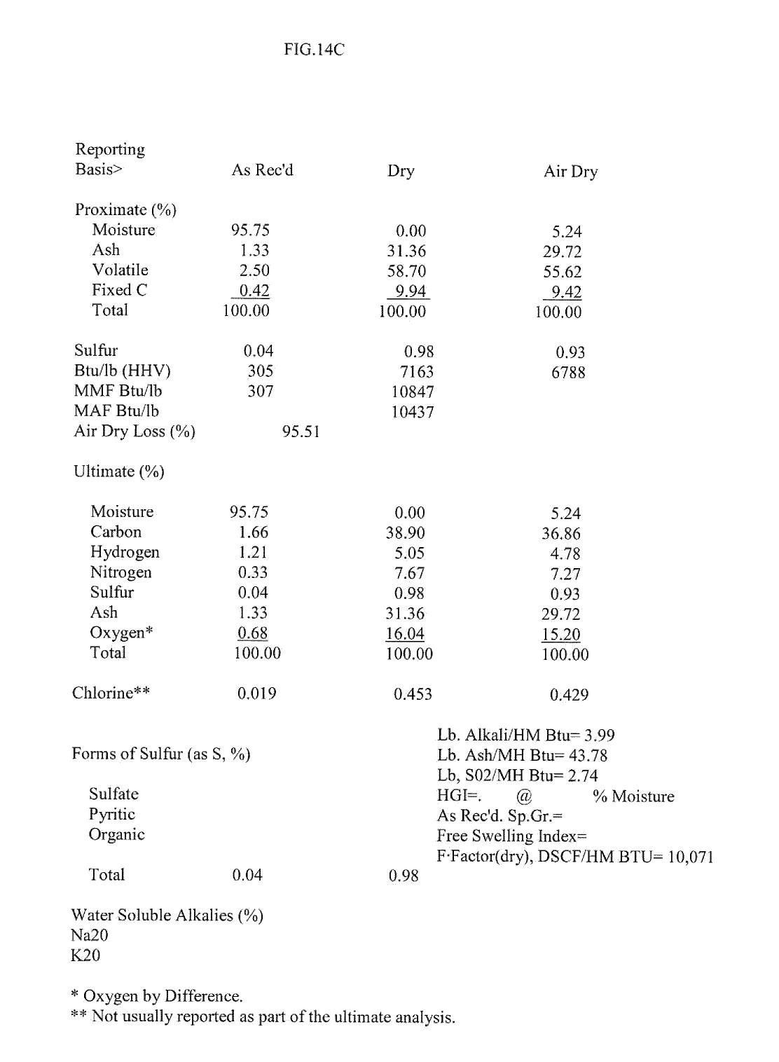

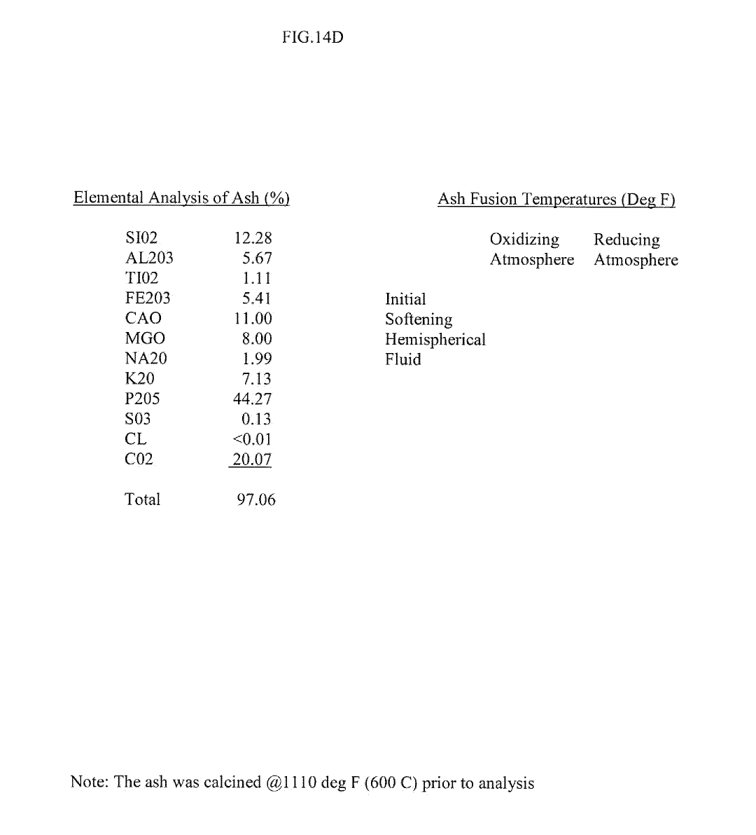

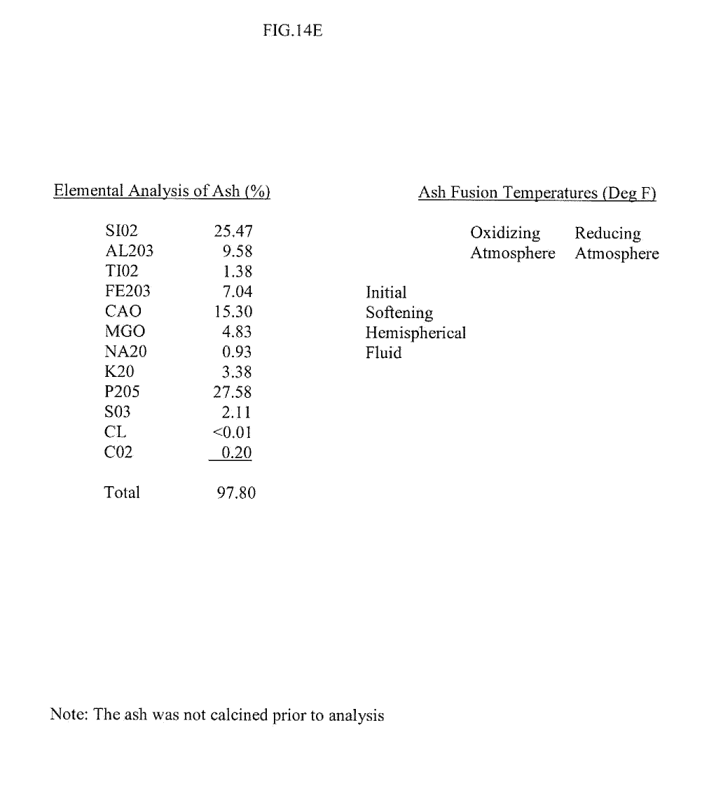

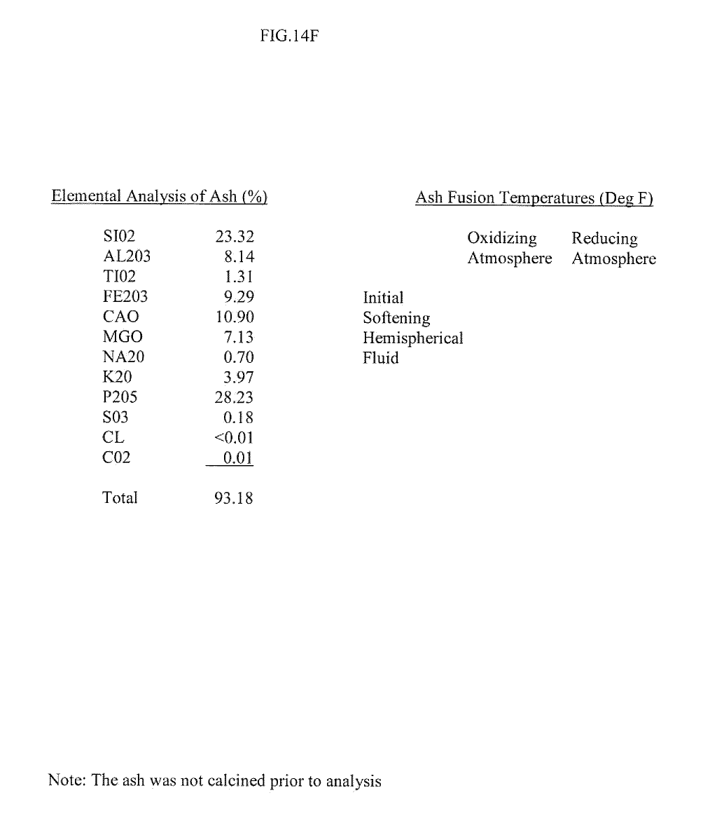

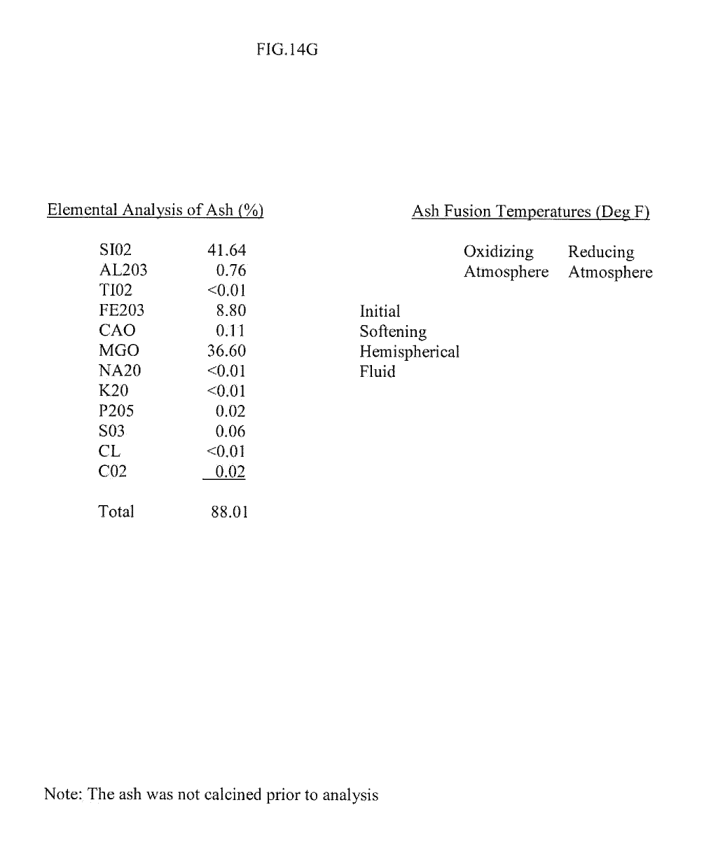

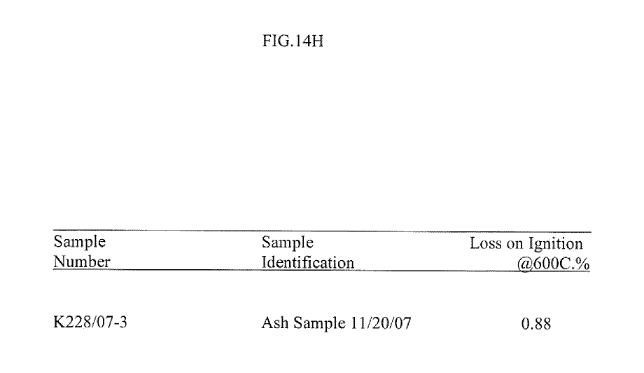

FIG. 7 shows a summary of the example chemical characteristics of Bio-P sludge as tabulated from FIG. 14.

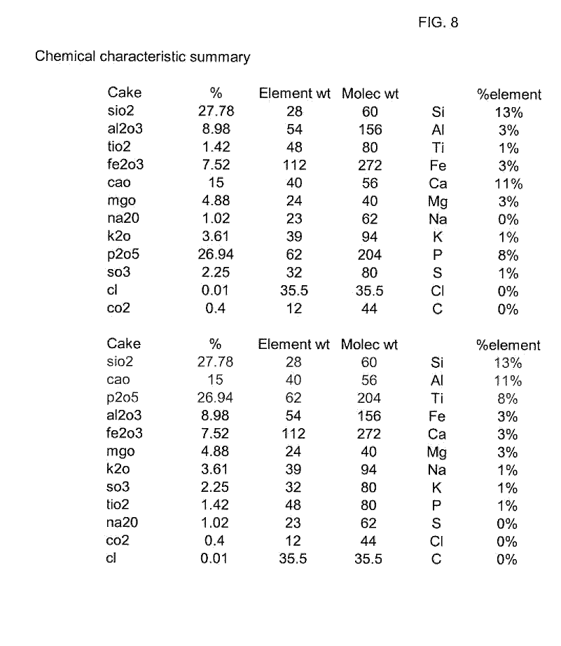

FIG. 8 shows example chemical characteristics of Bio-P dewatered sludge cake as tabulated from FIG. 14.

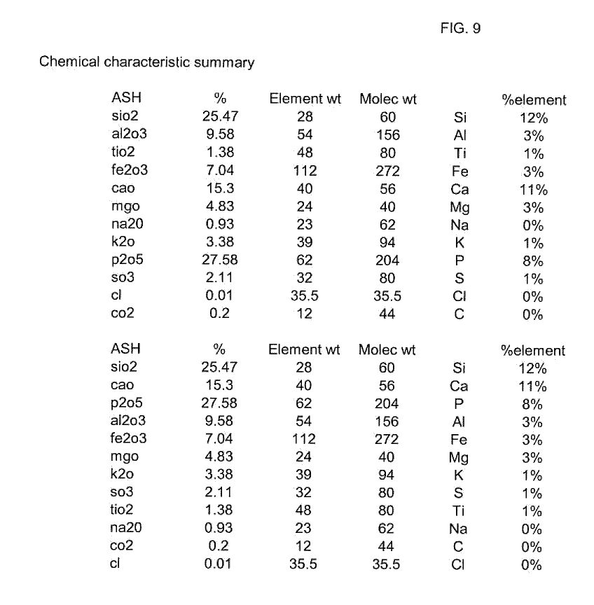

FIG. 9 shows example chemical characteristics of Bio-P ash as tabulated from FIG. 14.

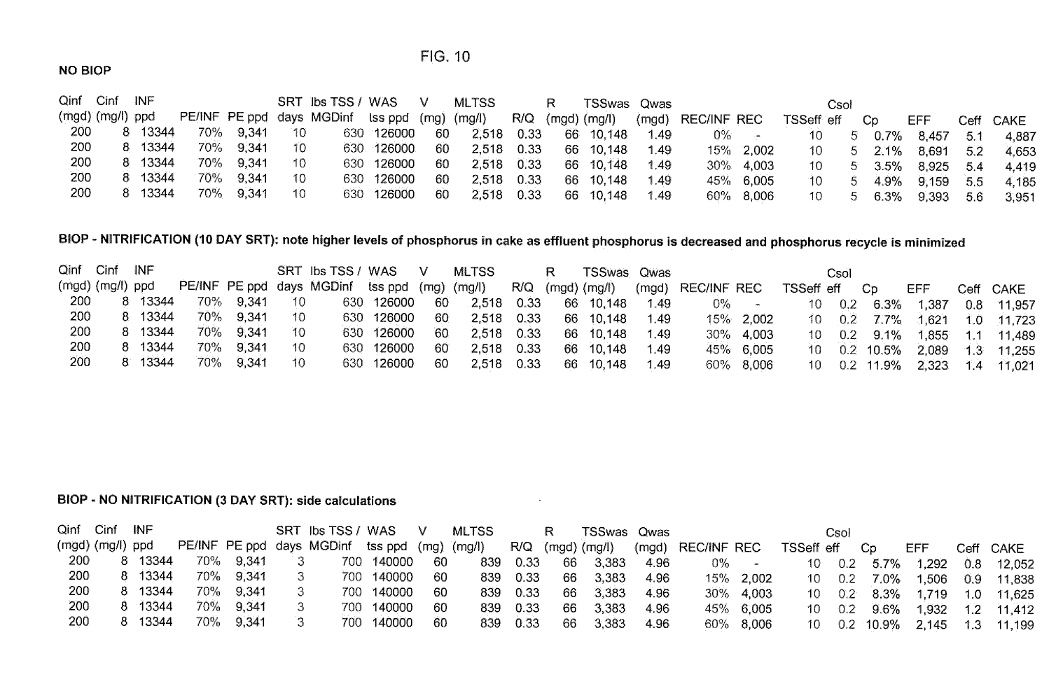

FIG. 10 shows the results of computer predictive modeling on sludge characteristics.

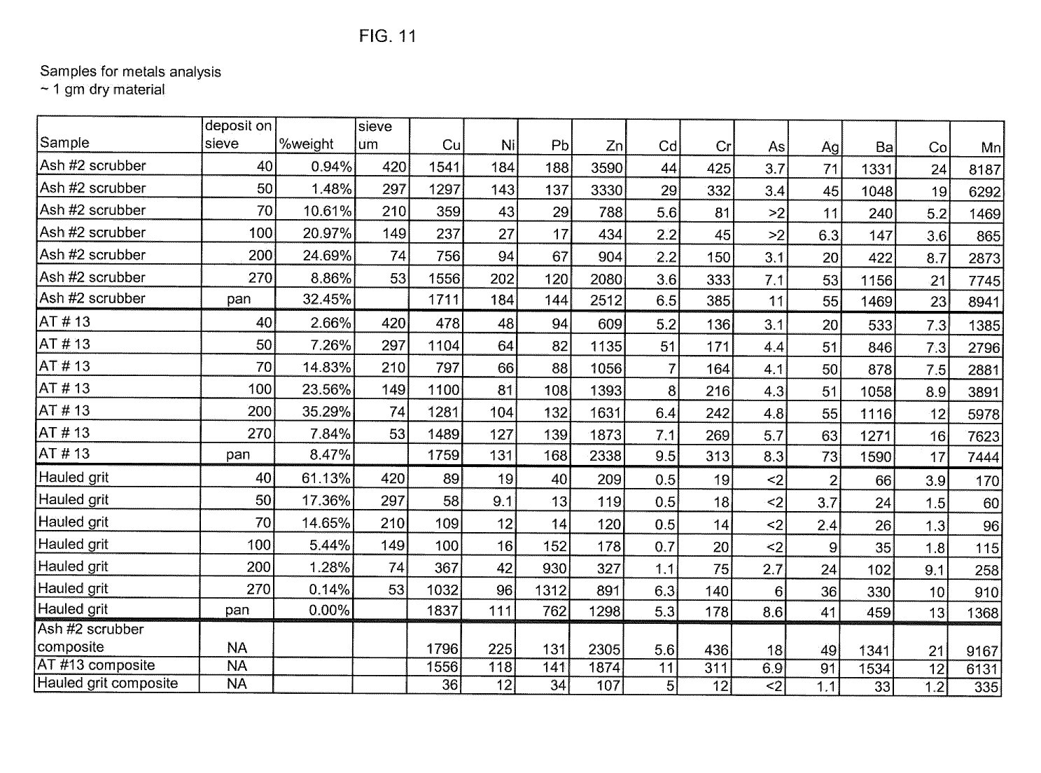

FIG. 11 shows example chemical parameter analysis based on various particle size distribution various ash, sludge and grit materials from a Bio-P wastewater treatment plant.

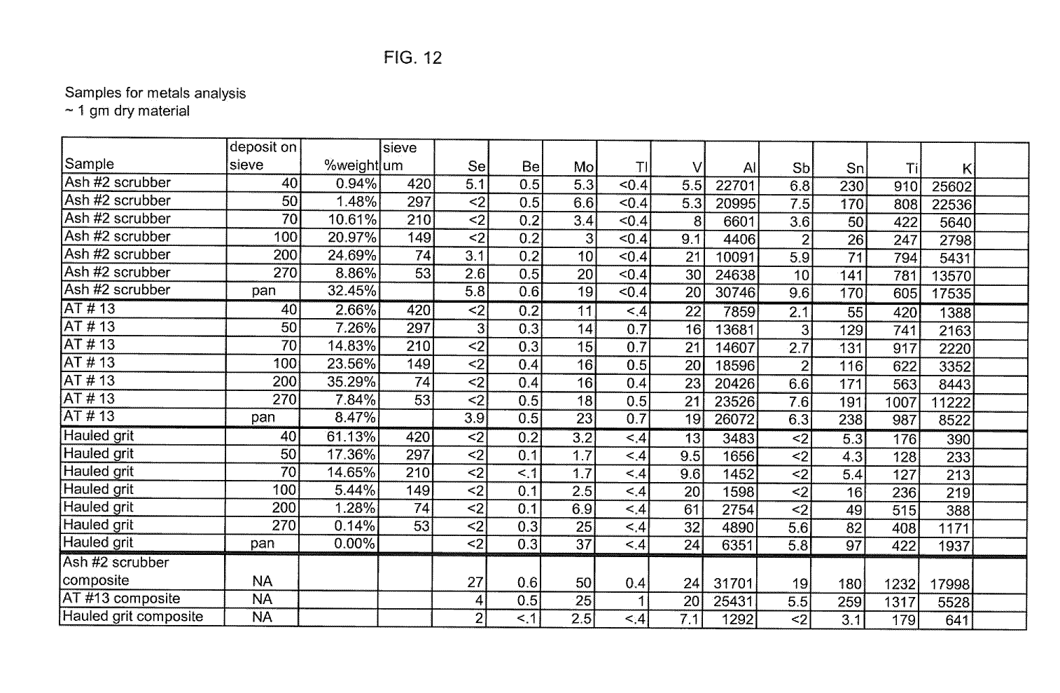

FIG. 12 shows example chemical parameter analysis based on various particle size distribution various ash, sludge and grit materials from a Bio-P wastewater treatment plant.

FIGS. 13A and 13B show the results of test results of phosphate removal from ash at various amounts and concentration of acid.

FIG. 14A-FIG. 14H show the test results for chemical parameters associated with Bio-P ash, liquid sludge and dewatered sludge cake.

The phosphorus content of the ash itself is compatible with direct use as a fertilizer product in its dry state.

The particle size of the ash is distributed in the range of 0.05 mm to 1 mm making it generally smaller than the typically used 1 mm to 3 mm particle size of commercial fertilizer products. Therefore direct use without grinding is available for applications that may require a fine particle size, such as amending powdered limestone.

For applications that desire larger particle sizes, the ash particles may be palletized with or without binder materials being added. The binding agent may also be a fertilizer material that balances the final product.

In another embodiment, the phosphate may be solubilized through liquidification using acid extractants. The use of sulfuric acid results in a sulfur component being added to the fertilizer product which may enhance the value of the final product. Of course, other acid materials can also be used to lower the pH and extract phosphorus.

Liquid phosphate is a high value product due to its versatility and ease of use. Using the disclosed process, a relatively high strength phosphate fertilizer may be produced. Under this embodiment, materials such as silicates may be separated from the phosphorus.

The results show that it is not necessary to use highly concentrated acid to obtain phosphorus release from the ash. If dilute acid is used to extract the phosphorus, in addition to the economic savings, the acid can be later concentrated resulting in exceptionally high phosphate concentrations in the final product.

As a result of this invention, a liquid or dry phosphate fertilizer may be produced from Bio-P sewage sludge, dewatered sludge, fly ash or ash which is easily stored, handled and delivered.

The invention produces a fertilizer product substantially free of pathogenic agents due to the low pH of the extractions, or the use of incinerator ash.

In a method for the production of a high phosphorus fertilizer product the steps of may include elevating phosphorus concentrations within a wastewater treatment sludge, incinerating the sludge within a sludge processing facility, concentrating the phosphorus within an ash and using the ash as the high phosphorus fertilizer product.

This method may have the additional step of mixing the ash with a phosphate ore to dilute problem parameters in a phosphate source such as aluminum, iron, magnesium or other metals. The phosphate containing feed material may include the additional step of extracting the phosphorus from the ash with an acid. The pH of the extractant may be adjusted with acids or basis to selectively remove or not remove elements from the feed material. For example, by extracting phosphorus at about pH 5 rather than at about pH 2, it may be possible to remove the phosphorus while reducing the amount of aluminum, iron, calcium or silica that is removed from the ash.

Alternatively, the method may include the additional step of removing unwanted materials by adjusting the pH of the acid after extracting the phosphorus. For example, aluminum may be removed as a byproduct by adjusting the pH of the extractant containing the phosphorus.

The high phosphorus fertilizer product may be produced in a palletized or liquid form through conventional technologies. Use of the method of the invention results in beneficial recycling of nutrients avoiding alternative waste disposal processes.

We claim:

1. A method for the production of a high phosphorus fertilizer product, comprising the steps of:
elevating phosphorus concentrations within a wastewater treatment sludge;
incinerating the sludge within a sludge processing facility;
concentrating the phosphorus within an ash;
using the ash as the high phosphorus fertilizer product.

2. The method of claim 1 having the additional step of mixing the ash with a phosphate ore.

3. The method of claim 1 having the additional step of extracting the phosphorus from the ash with an acid.

4. The method of claim 3 having the additional step of removing unwanted materials by adjusting the pH of the acid after extracting the phosphorus

5. The method of claim 1 wherein the high phosphorus fertilizer product is largely in pellet form.

6. The method of claim 1 wherein the high phosphorus fertilizer product is a liquid.

7. The method of claim 3 having the additional step of producing an aluminum byproduct.
